(19) United States
(12) Patent Application Publication
(10) Pub. No.: US 2005/0072395 A1
(43) Pub. Date: Apr. 7, 2005

(54) Cast combination comprising hollow sections of light-metal alloy

(76) Inventors: Wolfgang Bilger, Siegen (DE); Bernhard Commandeur, Wulfrath (DE); Thomas Dickmann, Oberhausen (DE); Jonathan W. Hinton, Bloomfield Hills, MI (US); Peter Krug, Velbert (DE); Guido Kubelstein, Wuppertal (DE); Raymond Loos, Petrut-Ebersviller (FR); Erik Mertner, Hattingen (DE); Gero Sinha, Velbert (DE); Jurgen Baumgarten, Wuppertal (DE)

Correspondence Address: KATTEN MUCHIN ZAVIS ROSENMAN, 575 MADISON AVENUE, NEW YORK, NY, 10022-2585, US

(21) Appl. No.: 10/995,443

(22) Filed: Nov. 23, 2004

Related U.S. Application Data
(63) Continuation of application No. PCT/EP03/08186, filed on Jul. 25, 2003.

(30) Foreign Application Priority Data
Aug. 6, 2002 (DE) 102 35 911.3

(51) Int. Cl. B22D 19/08; B22D 19/00; F02F 7/00

(52) U.S. Cl. 123/195 R; 164/98

(57) ABSTRACT

A method for producing a cast combination of cylindrical hollow profiles and for casting said combination into a cylinder block or crank housing of an internal combustion engine, wherein cylindrical hollow profiles consisting of a light-metal alloy and containing inlaid hard phases that have been manufactured by successive stages of spray compacting, hot extrusion and hot forming are arranged in a row, the distance between the axes of the hollow profiles corresponding to the cylinder bore center distance of the cylinder block and a light-metal alloy without inlaid hard phases is cast around said profiles. The cast combination is then positioned in a mould that forms the cylinder block and a light-metal material is cast around said combination.

### CROSS-REFERENCE TO RELATED APPLICATIONS

This is a continuation of International Application PCT/EP2003/008186, filed Jul. 25, 2003, which claims the benefit under 35 U.S.C. §119 from German Patent Application 102 35 911.3, filed Aug. 6, 2002.

### FIELD OF THE INVENTION

The present invention falls within the area of automotive engineering and relates in particular to cylindrical hollow sections, which are to be cast in place as cylinder liners in the cylinder block or in the crankcase of a reciprocating-piston internal-combustion engine.

### BACKGROUND OF THE INVENTION

Cylinder blocks or crankcases of internal-combustion engines are now generally made of alloyed aluminum in order to reduce weight. Unfortunately, inexpensive aluminum alloys that can be readily formed and machined are associated with the disadvantage of relatively low thermal resistance and poor wear resistance at the piston running surfaces of the cylinder bores. Such running surfaces are therefore unsuitable as direct running pairs for pistons equipped with piston rings.

It is known that the wear resistance of piston running surfaces can be increased by providing cylinder liners made, for example, from a hypereutectic aluminum-silicon alloy.

In this respect a problem exists in fixing the cylinder liners in the cylinder block or crankcase in such a way that they are secure against shifting and turning. For this purpose, either the liners are inserted into the cylinder block after it has been finish-machined, especially by being press-fitted or thermally joined, or the aluminum alloy is cast around them during casting of the cylinder block. Such casting in place of the cylinder liners can be regarded as the preferred manufacturing process.

Heretofore cylinder liners have been cast in place by positioning them individually in the casting mold of the crankcase, for example by slipping them onto conical core pins, and then casting the aluminum alloy around them (see, for example, German Patent 19904971 A1). If no special precautions are taken, however, this method also causes technical problems, which become evident in particular because a minimum web width must be maintained between the liners during casting in place. For example, in the conventionally used pressure die-casting method, it is necessary to maintain a spacing of at least several millimeters (generally 2 to 3 mm) between the liners, to ensure that the space between the liners is completely filled with molten metal and that the liners are fixed in the cylinder block in a manner that is secure against shifting and turning after the molten metal has solidified. This requirement is even more important for the slowly filling casting methods such as gravity casting and sand casting, in which much larger spacings must be maintained between the liners to ensure that the liners are completely cast in place.

As regards the manufacture of internal-combustion engines, the center-to-center spacing of the cylinder bores is a critical parameter for design of the engine. Any change thereof would result in far-reaching structural alterations. In order to avoid such problems, the center-to-center spacing of the cylinder bores is regarded as a quasi-constant parameter in practice. The same restrictions also apply for the overall length of the cylinder block and thus for the maximum length of the liners cast in place therein, which in turn predetermines the maximum possible piston stroke. Consequently, and because casting technology necessitates a minimum spacing between the liners, in turn limiting the diameter of the cylinder chambers, it follows that disadvantageous restrictions are imposed on the maximum achievable displacement for a given engine design.

Furthermore, it has also been shown that, if the spacing between the liners cast in place in the cylinder block is small, the strength of the web zone between the liners decreases. This is the case in particular for the torsional stiffness of the cylinder crankcase, which as known must withstand high torsional loads during operation of the internal-combustion engine. Particularly if the internal-combustion engine is running at high speed, the danger exists that cracks or fractures will develop in the web zone between the liners, in the worst case potentially leading to loosening of the liners and in turn to breakdown of the engine.

A further point worthy of mention is that, in modern internal-combustion engines, the cylinder-head gasket disposed between cylinder head and cylinder block is being subjected to ever-increasing loads because of the increasingly higher temperatures and pressures in the combustion chamber. In order to prevent leaks, the cylinder head must therefore be pressed (“preloaded”) with sufficiently high force onto the cylinder block, although it must be kept in mind that an excessive pressing force can lead to undesired deformations of the cylinder head or cylinder block. In particular, plastic deformation of material underneath the cylinder-head gasket (“pressure creep”) is favored by a high pressing force on the cylinder head. This effect occurs in particular in the region of the webs under the beads of the cylinder-head gasket, which beads are detrimental in this regard, and so leaks can develop, especially when the center-to-center spacing of the cylinder bores is small.

Moreover, in the conventional method for casting the liners in place in the crankcase or in the cylinder block, the problem is often encountered that the liners slipped onto the core pins cannot be fixed securely enough, and thus are moved during the process of casting in place. In practice, this has been found to be a frequent cause of the production of rejects.

Furthermore, when the liners are cast in place by means of slowly filling casting methods such as gravity casting and sand casting, the extremely serious problem occurs that an oxide film enveloping the molten metal prevents metallic bonding between the light-metal alloy of the crankcase and the light-metal alloy of the cylinder liner. For good bonding of the liners, however, the material being cast around the liners must cause slight incipient melting of their outer skin. For this purpose, the temperature of the molten metal must be raised. Since the liners and the crankcase are generally made of very similar alloys, however, it is likely that the cylinder liners will then melt completely through, at least in places. Because the volume of the crankcase is much larger than that of the liners, however, the process window in which liners and cylinder block or crankcase can be adequately bonded while the liners do not melt completely through, at least in places, cannot be controlled for series manufacture. In the slowly filling casting methods, therefore, precautions must be taken to prevent the liners from melting completely through, at least in places.

German Patent 3300924 C2 discloses a device for cooling cylinder webs in which cylinders cast closely and directly together (such as twin liners) of a cylinder block are used. German Patent 19532252 C2 discloses a method for production of cylinder liners from a hypereutectic Al—Si alloy. German Patent 69611751 T2 discloses a method for production of cylinder blocks in which cylinder liners are first combined in a liner array and then material is cast around the liner array in a casting mold. German Patent 69228954 T2 discloses a method for casting a cylinder block in which cylinder liners combined with one another are cast in place to produce a cylinder block. German Patent 10019793 C1 discloses a method for production of a cylinder liner for internal-combustion machines by thermal spraying of a wear-resisting layer and of a top layer onto a support member, the wear-resisting layer containing a hypereutectic Al—Si alloy and the top layer containing a eutectic or hypoeutectic Al—Si alloy. German Patent 4328619 discloses a partly reinforced casting as well as a method for production of same.

The object of the present invention is to overcome the disadvantages described hereinabove of the methods known in the prior art for casting hollow sections in place in a cylinder block or crankcase.

### SUMMARY OF THE INVENTION

This object is achieved according to the invention by a method for producing a cast combination comprising cylindrical hollow sections and for casting the cast combination in place in a cylinder block or crankcase of an internal combustion engine, in which method a light-metal alloy not containing interspersed hard phases is cast around cylindrical hollow sections, which are made by the successive steps of spray compaction, extrusion and hot forming from a light-metal alloy containing interspersed hard phases, and which have the form of a linear arrangement in which the axis-to-axis spacing of the hollow sections corresponds to the center-to-center spacing of the cylinder bores of the cylinder block, and the cast combination is positioned in a casting mold forming the cylinder block and light-metal material is cast around it.

According to the invention, there is shown for this purpose a cast combination comprising cylindrical hollow sections of a light-metal alloy containing interspersed hard phases, the cast combination being cast in place in a cylinder block or in a crankcase, thus forming the cylinder liners of an internal combustion engine, the cast combination being obtained by casting a light-metal alloy around a plurality of hollow sections in a linear arrangement, the spacing between the axes of the hollow sections corresponding to the center-to-center spacing of the cylinder bores of the cylinder block or crankcase. The arrangement of the hollow sections around which material is cast thus corresponds to a predetermined arrangement of the cylinder chambers of the cylinder block.

Since the volumes of the surrounding casting and of the hollow sections can be advantageously chosen to be approximately equal, good bonding of the hollow sections to the surrounding casting can be achieved according to the invention by slight incipient melting of the outer circumferential surfaces of the hollow sections, without the likelihood that the hollow sections will simultaneously melt completely through. In a subsequent second step, the cast combination comprising hollow sections is cast in place in the cylinder block or crankcase, in which process the material of the surrounding casting can be thought of as “sacrifice material”. The outer skin of the surrounding casting can be incipiently melted by the molten metal for good bonding of the cast combination in the cylinder block or crankcase, without the concern that the hollow sections will melt completely through, since the molten metal is generally solidified before it reaches the hollow sections. Thus even the slowly solidifying casting methods, such as gravity and sand casting in particular, can be used advantageously for casting the cast combination in place in the cylinder block.

Furthermore, the provision of sacrifice material ensures that the wall thickness of the hollow sections to be cast in place as liners can be reduced, with the economic benefit of savings in material that is specially adapted to the requirements of liners and that is generally relatively expensive.

In order to ensure that sufficient sacrifice material is available for casting the cast combination in place in the cylinder block or crankcase, the surrounding casting advantageously has a minimum thickness in the range of 2 to 5 mm.

Examples of established casting methods for casting material around hollow sections include low-pressure sand casting or low-pressure gravity casting. In principle, however, any desired casting method can be used for this purpose.

The material to be cast around the hollow sections is advantageously a readily formable light-metal alloy such as an aluminum alloy, in which there is no need for constituents that produce a hypereutectic content of hard phases. Preferably the same light-metal alloy can be used for casting material around the hollow sections and for casting the cylinder block or crankcase.

Since material has already been cast around the hollow sections and therefore molten metal no longer has to flow into the spaces between the hollow sections while the cast combination is being cast in place in the cylinder block, the spacing between the hollow sections to be cast in place as liners can be advantageously made smaller than in conventional casting in place of individual liners. It is even possible to cast material around the hollow sections without any spacing, meaning that their outer circumferential surfaces are touching, and then, once they have the form of the cast combination, to cast them in place as cylinder liners in a cylinder block. For given center-to-center spacing of the cylinder bores, it is then possible to increase the diameter of the liners compared with the prior art and accordingly to achieve a larger displacement per cylinder. Advantageously, therefore, larger displacements and thus higher powers of the internal-combustion engine are possible for given stroke length and given center-to-center spacing of the cylinder bores.

Because of the good bonding of the hollow sections in the surrounding casting and of the good bonding of the surrounding casting to the cylinder block or crankcase, it is always ensured that the cylinder liners are fixed in a manner that is secure against turning and shifting in the inventive cast combination comprising hollow sections, even if the liner spacings are very small or vanishingly small. In contrast to the prior art, where in particular the danger of loosening of individual liners exists in the case of very small web widths between the liners and in the case of high speeds of the internal-combustion engine, loosening of individual liners from the cast combination during operation of the internal-combustion engine is not a concern. Furthermore, because of the rigid cast combination comprising the hollow sections, the torsional stiffness of the cylinder block or crankcase is greatly improved.

For casting of the cast combination in place, the further advantage is evident that, in contrast to the prior art, where each liner must be fixed in position individually, the cast combination merely has to be positioned and fixed as a whole. Any movement of individual hollow sections during casting in place is prevented by the cast combination. In principle, positioning and fixing of the cast combination can be achieved more simply, more reliably and in particular more quickly than in the case of individual liners. This advantageously contributes to reducing the reject ratio during manufacture of cylinder blocks or crankcases and to accelerating the method because of the time saved.

In an advantageous embodiment of the inventive cast combination comprising hollow sections, the hollow sections are provided on their outer circumferential surfaces with abutting faces for mutual contact. These abutting faces can be, for example, flattened portions. Flattened portions have the particular advantage that the hollow sections can be cast in place with even smaller spacing and that thereby, for given center-to-center spacing of the cylinder bores and given longitudinal stroke, as well as allowing for a minimum necessary wall thickness of the hollow sections, the cross-sectional area of the hollow section and therefore the displacement of the liner can be even further increased.

The hollow sections can be positioned in such a way in the cast combination that their outer circumferential surfaces are in direct contact when material is cast around them; alternatively, the hollow sections can be spaced apart from one another, so that a web zone remains between the hollow sections. In particular, the spacing between adjacent hollow sections can be varied by means of the width of the web zone, and accordingly a predetermined center-to-center spacing of the cylinder bores of the cast-in-place liners can be chosen.

In modern internal-combustion engines, the cylinder-head gasket is being exposed to increasingly greater loads due to high temperatures and pressures in the combustion chamber, and for this reason the cylinder head must be pressed onto the cylinder block with very high pressing force. In order to avoid the associated detrimental consequences (such as pressure creep) thereof, it is advantageous to provide cooling to ensure that the yield point of the material cannot be reached, thus preventing plastic deformation.

For this purpose, the inventive cast combination can be advantageously provided, between the hollow sections around which material has been cast, with at least one channel for transport of cooling fluid, the channel being open at one or both ends. Such a channel can also be disposed in particular in the web zone between the hollow sections, if material is cast around the hollow sections in such a way that their outer circumferential surfaces are not directly in contact.

By cooling the material surrounding the channel with a pumped circulation of cooling fluid in the channel, it is advantageously possible to prevent the aforesaid material pressure creep caused by high preloading of the cylinder head.

If the hollow sections are in contact at their outer circumferential surfaces, such a cooling channel is preferably configured such that it is recessed into at least one of the outer circumferential surfaces of the hollow sections within the contact joint of the hollow sections. For example, the channel can be formed either by a recess of only one outer circumferential surface or by recesses in the outer circumferential surfaces of both hollow sections, in which case they combine to comprise one channel.

Alternatively, the channel can be formed by a channel-shaped hollow section disposed between the hollow sections. This is positioned between the hollow sections and then material is cast around it during production of the combination. Furthermore, the channel for transport of cooling fluid can be formed by a spacer section disposed between the hollow sections. This is positioned between the hollow sections and then material is cast around it during production of the combination. The spacer section differs from the channel-shaped hollow section in that the channel is formed exclusively by the channel-shaped hollow section, whereas, in the case of the spacer section, portions of the outer circumferential surfaces of the adjacent hollow sections also participate for this purpose.

By suitable choice of the dimensions of the channel-shaped hollow section or spacer section along the linear arrangement of hollow sections, the spacing of the hollow sections can also be varied with regard to a predetermined center-to-center spacing of the cylinder bores.

Furthermore, a channel for transport of cooling fluid can also be recessed in the surrounding casting of the hollow sections. To form such channels, suitable salt or sand cores are positioned in the material of the surrounding casting as it is being cast around the hollow sections.

Advantageously, a channel for transport of cooling fluid is disposed substantially only at the level of that space of the hollow sections cast-in-place as liners which is intended for combustion of fuel, in order to achieve cooling of the zones most exposed to the high temperatures.

In particular, it is preferred that such a channel be disposed substantially only at the level of that end of the hollow sections cast-in-place as liners which is adjacent to the cylinder-head gasket, so that it is mainly the zone adjacent to the cylinder-head gasket that is cooled, and pressure creep of the material disposed directly under the cylinder-head gasket can be suppressed.

According to the invention, the hollow sections formed from a light-metal alloy containing interspersed hard phases can be made of an aluminum-silicon alloy, which if necessary is hypereutectic. In this alloy the interspersed hard phases are formed by silicon. Examples of other constituents suitable as hard phases in the aluminum matrix include SiC, TiO or AlO.

The content of silicon in the aluminum-silicon alloy is advantageously 12 to 40 wt %, preferably 17 to 30 wt %, and especially preferably 25 wt %, in each case relative to the total weight of the alloy.

The hollow sections to be cast in place as liners and formed from light-metal alloy containing interspersed hard phases, for example from a hypereutectic aluminum-silicon alloy, are advantageously produced by the spray-compaction method, which is known in itself and therefore does not have to be explained in more detail here.

The material for making the channel-shaped hollow section comprising the cooling channel is advantageously a readily formable light-metal alloy, such as an aluminum alloy, in which there is no need for a hypereutectic content of constituents that produce hard phases.

The light-metal alloy used for casting material around the hollow sections can be an aluminum-silicon alloy which, by virtue of better formability, is advantageously an alloy with a hypoeutectic content of silicon. If the hollow sections are also made of an aluminum-silicon alloy, the aluminum-silicon alloy used for casting material around the hollow sections preferably has a lower Si content than the aluminum-silicon alloy used for the hollow sections. For example, the alloy of the hollow sections can have a silicon content of 25 wt % and that of the surrounding casting can have a silicon content of 9 wt %, in each case relative to the total weight of the alloy. If an aluminum-silicon alloy is also used for the cylinder block, the silicon content of that alloy will generally be even higher than in the alloy of the cast combination comprising the hollow sections, so that the Si content of the alloys used decreases gradually from inside to outside. This advantageously helps to prevent thermal stresses due to differences in the nature of the alloys used.

In the inventive hollow-section combination, the hollow sections to be cast in place as liners advantageously have a wall thickness in the range of 3 to 8 mm, especially preferably approximately 4 mm.

The cast combination preferably comprises 2, 3, 4, 5, 6 or 8 hollow sections. For example, a cast combination comprising 4 hollow sections in a surrounding casting can be cast in place as liners in the cylinder block of a straight-four engine, or two such combinations can be cast in place as liners in the cylinder block of a V8 engine (2 rows of 4 cylinders each). Correspondingly, a V6 engine can be equipped with two individual cast combinations, each comprising 3 hollow sections in a surrounding casting as liners.

For accurate and simple positioning while being cast in place in a cylinder block or crankcase, the hollow-section combination is advantageously provided with positioning or identifying marks, which for this purpose can be made on the cast combination.

The subject matter of the invention further includes a method for producing an inventive cast composition of hollow sections as described in the foregoing, wherein a light-metal alloy is cast around cylindrical hollow sections made by the successive steps of spray compaction, extrusion and hot forming. In particular, the billets created by spray compaction are extruded at a temperature in the range of 300 to 550° C. and then squeezed to round shape at a temperature of 300 to 450° C.

In the conventional process, in which hollow sections are separately cast in place as liners in a cylinder block, the problem often occurs that the molten metal flowing to the end adjacent to the cylinder-head gasket is already cooled to such an extent that the hollow sections are no longer completely surrounded by cast material and so portions of the liners are exposed. As a result, liners that were cast in place so poorly begin to vibrate during operation of the internal combustion engine, and in the worst case the liner can become so loose that engine breakdown can be expected.

In order to avoid this problem, it is particularly advantageous, in the inventive method of casting material around the hollow sections in order to obtain a combination, to cast additional material onto the hollow sections at that end of the liners which faces the cylinder-head gasket once they have been cast in place. Thus it is unimportant if material in the form of “cold” molten metal is poorly cast around the hollow sections, since the hollow sections have already been thoroughly cast in place. The additional material cast onto the liners can be subsequently machined off once again during completion of the cylinder block.

Furthermore, the invention relates to a method for casting in place an inventive cast combination comprising hollow sections such as described hereinabove, wherein the cast combination is positioned in a casting mold forming the cylinder block and light-metal alloy is cast around it. For this purpose the pressure die-casting method is preferably used. Advantageously, the cast combination comprising hollow sections is positioned in the casting mold by means of positioning marks made on the hollow-section combination. If the hollow-section combination has been provided with channels, it is advantageous to place salt or sand cores impermeable to molten metal in the channels.

### BRIEF DESCRIPTION OF THE DRAWINGS

The invention will now be explained in more detail on the basis of a practical example with reference to the attached drawing, wherein:

FIG. 1 shows a side view, at right angles to the axis of the hollow sections, of an inventive cast combination.

### DETAILED DESCRIPTION OF THE INVENTION

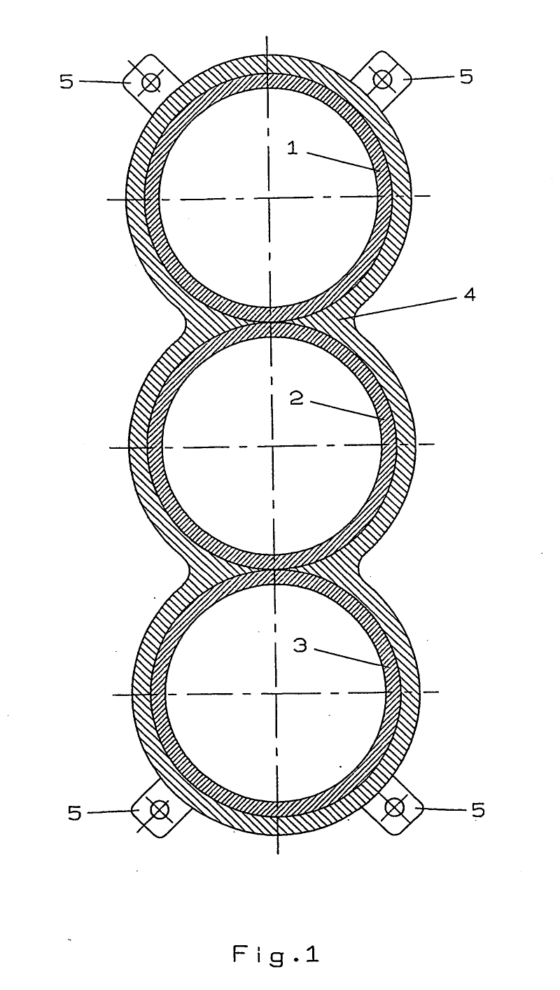

In the inventive cast combination illustrated in FIG. 1, material has been cast around three individual cylindrical hollow sections 1, 2, 3. The three cylindrical hollow sections 1, 2, 3 are cast together in line, directly at their outer circumferential surfaces, without space between them, in such a way that the hollow-section axes have a spacing corresponding to the predetermined center-to-center spacing of the cylinder bores of the cylinder block.

The hollow sections were made by spray compaction, from an aluminum-silicon alloy having a silicon content of 25 wt % relative to the total weight of the alloy. The wall thickness of the hollow sections is 4 mm.

Hollow sections 1, 2, 3 are cast together in a surrounding casting 4 of aluminum-silicon alloy having good castability and a silicon content of 9 wt % relative to the total weight of the alloy. The minimum thickness of the surrounding casting is at least 2 mm.

Positioning marks 5 for casting the cast combination in place in a cylinder block are made on the cast combination.

Two such combinations of three hollow sections are suitable, for example, for casting in place as the liners for a V6 engine (2 rows of 3 cylinders each).

1. A method for producing a cast combination comprising cylindrical hollow sections and for casting the cast combination in place in a cylinder block or crankcase of an internal combustion engine, in which method
a light-metal alloy not containing interspersed hard phases is cast around cylindrical hollow sections, which are made by the successive steps of spray compaction, extrusion and hot forming from a light-metal alloy containing interspersed hard phases, and which have the form of a linear arrangement in which the axis-to-axis spacing of the hollow sections corresponds to the center-to-center spacing of the cylinder bores of the cylinder block, and
the cast combination is positioned in a casting mold forming the cylinder block and light-metal material is cast around it.

2. A method according to claim 1, in which, during production of the cast combination, additional material is cast onto the hollow sections at that end of the liners which faces the cylinder-head gasket once they have been cast in place.

3. A method according to claim 1, in which, during production of the cast combination, a channel is created in the surrounding casting by positioning salt or sand cores that are impermeable to molten metal.

4. A method according to claim 1, in which positioning of the cast combination is achieved by positioning marks made on the combination.

5. A method according to claim 3, in which salt or sand cores impermeable to molten metal are placed in the channels.

6. A cast combination, produced by the method according to claim 1, comprising cylindrical hollow sections of a light-metal alloy containing interspersed hard phases, and intended for casting in place as cylinder liners in a cylinder block or crankcase of an internal-combustion engine.

7. A cast combination according to claim 6, in which the hollow sections are provided on their outer circumferential surfaces with abutting faces, especially in the form of flattened portions, for mutual contact.

8. A cast combination according to claim 6, in which at least one channel for transport of cooling fluid is provided between two adjacent hollow sections, the channel being open at one or both ends.

9. A cast combination according to claim 8, in which the channel is recessed into at least one of the outer circumferential surfaces of the hollow sections.

10. A cast combination according to claim 8, in which the channel is formed by a channel-shaped hollow section disposed between adjacent hollow sections.

11. A cast combination according to claim 8, in which the channel is formed by a recess in the surrounding casting between adjacent hollow sections.

12. A cast combination according to claim 8, in which the channel is disposed substantially only at the level of that space of the hollow sections cast-in-place as liners which is intended for combustion of fuel.

13. A cast combination according to claim 8, in which the channel is formed substantially only at the level of that end of the hollow sections cast-in-place as liners which is adjacent to the cylinder-head gasket.

14. A cast combination according to claim 6, in which the hollow sections are made of an aluminum-silicon alloy.

15. A cast combination according to claim 14, in which the silicon content of the aluminum-silicon alloy is 12 to 40 wt % relative to the total weight of the alloy.

16. A cast combination according to claim 14, in which the silicon content of the aluminum-silicon alloy is 17 to 30 wt % relative to the total weight of the alloy.

17. A cast combination according to claim 14, in which the silicon content of the aluminum-silicon alloy is 25 wt % relative to the total weight of the alloy.

18. A cast combination according to claim 14, in which the hollow sections are produced by spray compaction.

19. A cast combination according to claim 14, in which the light-metal alloy used for casting material around the hollow sections is an aluminum-silicon alloy.

20. A cast combination according to claim 19, in which the aluminum-silicon alloy used for casting material around the hollow sections has a lower Si content than the aluminum-silicon alloy used for the hollow sections.

21. A cast combination according to claim 20, in which the aluminum-silicon alloy used for casting material around the hollow sections has a hypoeutectic Si content.

22. A cast combination according to claim 14, in which the hollow sections have a wall thickness in the range of 3 to 8 mm.

23. A cast combination according to claim 14, in which the hollow sections have a wall thickness of approximately 4 mm.

24. A cast combination according to claim 14, which is provided with positioning marks for positioning the cast combination while it is being cast in place in the cylinder block or in the crankcase.

25. A cast combination according to claim 6, which comprises 2, 3, 4, 5, 6 or 8 hollow sections.

26. A cast combination according to claim 6, in which the light-metal alloy used for casting material around the hollow sections is the same as the light-metal alloy used for the cylinder block.

27. A cast combination according to claim 6, in which the surrounding casting of the hollow sections has a minimum thickness in the range of 2 to 5 mm.

28. A cylinder block or crankcase containing a cast-in-place cast combination comprising hollow sections according to claim 6.
